(19) United States
(12) Patent Application Publication
(10) Pub. No.: US 2015/0125845 A1
(43) Pub. Date: May 7, 2015

(54) SERVER AND METHOD FOR PROVIDING LEARNER-CUSTOMIZED LEARNING SERVICE

(71) Applicant: Teracle, Inc., Seoul (KR)

(72) Inventors: In Je CHO, Seoul (KR); Hoon Je CHO, Seoul (KR)

(73) Assignee: Teracle, Inc., Seoul (KR)

(21) Appl. No.: 14/191,418

(22) Filed: Feb. 26, 2014

(30) Foreign Application Priority Data
Nov. 1, 2013 (KR) 10-2013-0132542

(51) Int. Cl. G09B 7/04

(52) U.S. Cl. CPC G09B 7/04
USPC 434/353

(57) ABSTRACT

A server and method for providing a learner-customized learning service are provided, whereby a correct answer rate is checked based on a real-time solving process and/or solving time for answering a question provided to a learner terminal such as a fixed terminal such as a computer or a portable terminal such as a smartphone. A difficulty level of the questions addressed to the learner terminal is adjusted and the questions are provided according to the correct answer rate. Therefore, learning materials are managed and provided to the learner terminal according to the learner terminal's ability.

### RELATED APPLICATIONS

This application claims the priority of Korean Patent Application No. 10-2013-0132542, filed on Nov. 1, 2013, in the Korean Intellectual Property Office, the disclosure of which is incorporated herein in its entirety by reference.

### BACKGROUND

1. Field

One or more embodiments of the present invention relate to a server and method for providing a learner-customized learning service, and more particularly, to server and method for providing a learner-customized learning service, whereby a correct answer rate is checked based on a process and time for answering questions provided to a learner by using a fixed terminal such as a computer or a portable terminal such as a smartphone and the difficulty levels of the questions addressed to the learner are adjusted and the questions are provided based on the correct answer rate so that learning materials are managed and provided to the learner according to the learner's ability.

2. Description of the Related Art

As the Internet and personal communication technologies have considerably developed recently, a learning method using an electronic tool such as remote learning, video learning, or the like has been widely used for educational purposes. According to this learning method, lectures and tests are provided via an on-line environment, and learning is performed only in a fixed setting by using an individual personal computer (PC). However, as use of wireless Internet devices has rapidly increased, online learning is also possible by using a smartphone, a table PC, or the like while a learner is on the move.

However, this online learning allows a learner to learn by accessing learning materials stored in a server. Therefore, like in the case of using a learning video tape, a student may unilaterally receive an audio-visual educational material. Therefore, when a lecture provided online has a difficulty level that does not match a learning ability of a learner and the learner has difficulties in understating the lecture, the learner has no other choice but to continuously watch the lecture regardless of his/her learning.

Therefore, if the learner accidentally gets a correct answer or gets a correct answer without completely understanding the concepts and principles provided via the lecture, weak learning of the learner may not be corrected after answering the questions. As a result, there is a limit in improving the real learning ability of the learner.

### CITED REFERENCE

### Patent Document

(Patent Document 1) Korean Patent Publication No. 2011-0092140

### SUMMARY

One or more embodiments of the present invention include a server and method for checking a correct answer rate based on a real-time process and time for answering questions addressed to a learner by using a fixed terminal such as a computer or a portable terminal such as a smartphone and adjusting the difficulty levels of the questions and providing the questions according to the correct answer rate in order to accurately analyze the learning types of learners in order to help learning.

One or more embodiments of the present invention include a server and method for providing a learning process matching a level of a learner in order to induce phased and self-directed learning.

One or more embodiments of the present invention include a server and method for checking a correct answer rate based on a real-time process and/or time for answering questions addressed to a learner by using a fixed terminal such as a computer or a portable terminal such as a smartphone in order to induce accurate learning of the learner.

One or more embodiments of the present invention include a server and method for checking a real-time process and/or time for answering questions addressed to a learner by using a fixed terminal such as a computer or a portable terminal such as a smartphone, regardless the time and place of answering the questions in order to improve a learning interest of the learner.

One or more embodiments of the present invention include a server and method for checking a correct answer rate of questions answered by a learner in real time in order to improve a learning performance.

Additional aspects will be set forth in part in the description which follows and, in part, will be apparent from the description, or may be learned by practice of the presented embodiments.

According to one or more embodiments of the present invention, a method of providing a learner-customized learning service through a server, includes: providing a question to a learner terminal; receiving a solving process of the question from the learner terminal in real time; calculating a solving process correctness and a correct answer rate of the question received from the learner terminal in real time; and adjusting a difficulty level of the question provided to the learner terminal according to the correct answer rate.

The method may further include: providing learning evaluation contents in real time according to a request of the learner terminal and/or a manager terminal.

The method may further include: providing the learning evaluation contents in text forms and/or graphic forms in real time according to a request of the learner terminal.

The method may further include: adjusting and transmitting the difficulty level of the question provided to the learner terminal according to the learning evaluation contents through the manager terminal.

The method may further include: if the correct answer rate of the learning evaluation contents of the learner terminal is higher than a reference rate, upgrading and transmitting a difficulty level through the manager terminal, and if the correct answer rate of the learner terminal is lower than the reference rate, lowering and transmitting a difficulty level through the manager terminal.

The providing of the learning evaluation contents may include: comparing the solving process with an answer keyword; and calculating the solving process correctness according to the numbers of solving processes and the answer keywords that match with each other.

The method may further include: if the solving process correctness is higher than or equal to the reference rate, processing an answer of the learner as a correct answer.

The providing of the learning evaluation contents may further include: receiving a solving time of the question. If the solving time of the question exceeds a time limit or a preset reference time provided to the learner terminal, processing the answer of the learner terminal as a wrong answer.

The providing of the learning evaluation contents may further include: receiving a solving time of the question. A first weight may be applied to the solving time, and a second weight may be applied to the solving process correctness to calculate a accuracy

The providing of the learning evaluation contents may include: calculating the correct answer rate according to the solving time and solving process correctness of the question.

The adjusting of the difficulty level may include: determining the difficulty level of the learner terminal based on the preset number of learning evaluations.

The adjusting of the difficulty level may include: adjusting a difficulty level of each question of the learner terminal and providing the adjusted difficulty level to the learner terminal.

The method may further include: if a correct answer of each question of the learner terminal is higher than a reference rate, upgrading and transmitting a difficulty level of a next question, and if the correct answer of each question of the learner terminal is lower than the reference rate, lowering and transmitting the difficulty level of the next question.

The adjusting of the difficulty level may include: adjusting a difficulty level of each test of the learner terminal and providing the adjusted difficulty level to the learner terminal.

The method may further include: if a correct answer rate of each test of the learner terminal is higher than a reference rate, upgrading and transmitting a difficulty level of a next test, and if the correct answer rate of each test of the learner terminal is lower than the reference rate, lowering and transmitting the difficulty level of the next test.

According to one or more embodiments of the present invention, a server for providing a learner-customized learning service, includes: a question providing module which provides a question to a learner terminal; a solving process check module which calculates a solving process correctness of the question received from the learner terminal; a correct answer rate calculating module which calculates a correct answer rate according to the solving process correctness; a learning evaluating module which generates in real time learning evaluation contents comprising a solving time, the solving process correctness, the correct answer rate, and accuracy of the question according to each learner terminal; and a difficulty level adjusting module which adjusts a difficulty level of the learner terminal according to the correct answer rate.

The learning evaluating module may provide the learning evaluation contents in real time according to a request of the learner terminal and/or a manager terminal.

The manager terminal may adjust and transmit a difficulty level of the question of the learner terminal according to the learning evaluation contents.

The difficulty level adjusting module may adjust a difficulty level of each question of the learner terminal and provide the adjusted difficulty level to the learner terminal.

The difficulty level adjusting module may adjust a difficulty level of each test of the learner terminal and provide the adjusted difficulty level to the learner terminal.

### BRIEF DESCRIPTION OF THE DRAWINGS

These and/or other aspects will become apparent and more readily appreciated from the following description of the embodiments, taken in conjunction with the accompanying drawings in which:

FIG. 1 is a view illustrating a system for providing a learner-customized learning service, according to an embodiment of the present invention;

FIG. 2 is a schematic block diagram illustrating a structure of a learner terminal that executes a learner-customized learning service application, according to an embodiment of the present invention;

FIG. 3 is a flowchart of a process of transmitting a question solving time and a question solving process through a learner-customized learning service application and checking the transmission result in a learner terminal, according to an embodiment of the present invention;

FIGS. 4A through 4D are views illustrating screens that display question solving processes on learner terminals, according to an embodiment of the present invention;

FIGS. 5A and 5B are views illustrating a screen that displays an adjusted difficulty level of a question on a learner terminal, according to an embodiment of the present invention;

FIGS. 6A and 6B are views illustrating a screen on which a question solving result is checked on a learner terminal, according to an embodiment of the present invention;

FIG. 7 is a schematic block diagram illustrating a structure of a manager terminal that executes a learner-customized learning service application, according to an embodiment of the present invention;

FIG. 8 is a flowchart illustrating a process of checking a question solving result of a learner through a learner-customized learning service application in a manager terminal, according to an embodiment of the present invention;

FIGS. 9A through 9D are views illustrating a screen on which a question solving result of a learner is checked on a manager terminal, according to an embodiment of the present invention;

FIG. 10 is a view illustrating a screen to adjust a difficulty level of questions for a learner in a manager terminal, according to an embodiment of the present invention;

FIG. 11 is a schematic block diagram illustrating a structure of a server for providing a learner-customized learning service, according to an embodiment of the present invention; and

FIG. 12 is a flowchart illustrating a process of adjusting difficulty levels for learners according to a correct answer rate through a server for providing a learner-customized learning service and providing the adjusted difficulty levels to a manager terminal and a learner terminal, according to an embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

It will be understood that, although the terms, ‘first’, ‘second’, etc. may be used herein to describe various elements, these elements should not be limited by these terms. These terms are only used to distinguish one element from another.

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

In the current embodiments, the terms “communication”, “communication network”, “Internet”, and “network” may have the same meaning. Also, these terms may refer to a wire/wireless short-distance and/or wide area data transmitting and receiving network through which a specific user terminal, terminals of other users, and a download server may transmit and receive data.

Hereinafter, the present invention will be described in detail by explaining the embodiments of the invention with reference to the attached drawings. Like reference numerals in the drawings denote like elements.

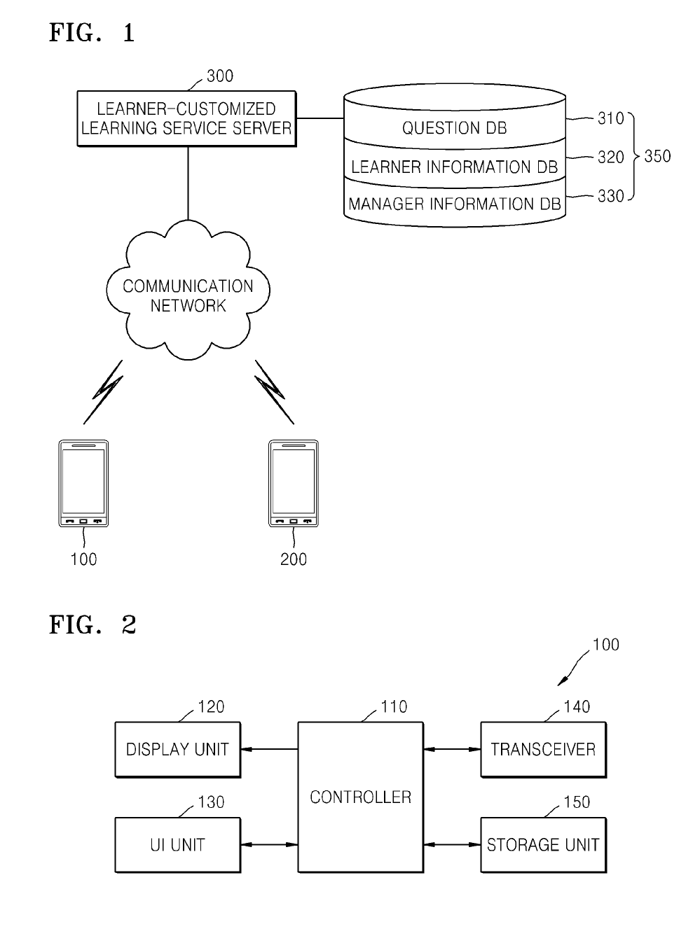

FIG. 1 is a view illustrating a system for providing a learner-customized learning service, according to an embodiment of the present invention.

Referring to FIG. 1, the system includes a learner terminal 100, a manager terminal 200, and a learner-customized learning service server 300. The system may include other elements besides the above-mentioned elements.

The learner terminal 100 and the manager terminal 200 are apparatuses that may access the learner-customized learning service server 300 through a communication network. The learner terminal 100 and the manager terminal 200 may be mobile terminals such as notebook computers, hand-held devices, smartphones, taps, tablet PCs, or the like, desktop computers, or apparatuses that use these devices or are directly or indirectly connected to these devices.

The learner terminal 100 accesses the learner-customized learning service server 300 to download and install a learner-customized learning service application for solving questions and checking results of solving the questions in real time.

The learner terminal 100 also executes the learner-customized learning service application to access the learner-customized learning service server 300, receives pre-registered questions from the learner-customized learning service server 300, and displays the questions. The questions may be of various types. For example, if a learner is a high school student, the questions may be questions regarding curriculum subjects such as Korean, English, mathematics, etc. Alternatively, the questions may be questions that are used by designated education institutes to evaluate learners according to class units, school units, city units, province units, and nation units. The questions may also be subjective questions, objective questions, questions implying solving processes, or essay questions requiring opinions of examinees. When the learner terminal 100 receives a question from the learner-customized learning service server 300, the learner terminal 100 may also receive a time limit for answering each of the questions.

The learner terminal 100 may record a solving process in an area based on the question received from the learner-customized learning service server 300. The solving process may indicate a series of mathematical equations for finding a correct answer. If the question is an essay question, the solving process may be a sentence or a paragraph including a series of words for providing a correct answer. When the question is an objective question, the learner terminal 100 may record a selected correct answer along with the solving process.

The learner terminal 100 may completely write the solving process of the question and transmit an answer to the question and/or the solving process of the question to the learner-customized learning service server 300. The learner terminal 100 may also transmit a time taken for solving the question. Alternatively, the learner terminal 100 may transmit a result value as to whether the question is solved within the transmitted time limit to the learner-customized learning service server 300.

When the learner terminal 100 receives a next step question after transmitting a solving process of a previous step question, the learner terminal 100 may receive a question of which difficulty level is adjusted according to a correct answer rate of the previous step question. The learner terminal 100 may also transmit a question solving time when transmitting the solving process of the previous step question. The learner terminal 100 may also receive a next test of which difficulty level is adjusted according to a correct answer rate of a previous test. In other words, the learner terminal 100 may receive a question of which difficulty level is adjusted or questions related to a test of which difficulty level is adjusted. The learner terminal 100 may receive a next question of which difficulty level is adjusted based on the preset number of learning evaluations performed by the manager terminal 200 or the learner-customized learning service server 300.

The learner-customized learning service server 300 may provide a result of a correct answer rate of a corresponding question to the learner terminal 100 according to a request of the learner terminal 100. The learner-customized learning service server 300 may provide the learner terminal 100 with a result regarding whether a correct answer rate, a question solving time, a solving process correctness, and/or a time limit are kept.

The manager terminal 200 accesses the learner-customized learning service server 300 to check a question solving result of a learner in real time or download and install a learner-customized learning service application for adjusting a question difficulty level of the learner.

The manager terminal 200 executes the learner-customized learning service application to access the learner-customized learning service server 300, receives a question solving result of a learner who has taken a test from the learner-customized learning service server 300 in real time, and display the question solving result. The question solving result may be a learning evaluation content of a correct answer rate that is calculated from a question solving accuracy of a learner who takes a test. However, the question solving result may be a learning evaluation content that indicates a result regarding whether a question solving time, a correct answer rate, a question solving correctness, an accuracy, and/or a time limit are kept. The manager terminal 200 may check a learning evaluation content of each learner from the learner-customized learning service server 300 to induce accurate learning of the learner or improve a learning efficiency. The manager terminal 200 may adjust a difficulty level of a next question or a next test according to a question solving result of a learner who has taken a test and transmit the adjusted difficulty level to the learner-customized learning service server 300. The manager terminal 200 may adjust a difficulty level based on the preset number of learning evaluations received from the learner-customized learning service server 300 and transmit the adjusted difficulty level to the learner-customized learning service server 300.

The learner-customized learning service server 300 is connected to the learner terminal 100 and the manager terminal 200 through the communication network.

The learner-customized learning service server 300 may be realized as hardware of a computing device that may be accessed by users to perform a program generating learning contents, software, or circuits. A plurality of production programs may be operated in one learner-customized learning service server 300, and one or more learner-customized learning service servers 300 for operating the production programs may exist according to functions thereof.

At least some of elements constituting the learner-customized learning service server 300 may be constituted as software including at least one or more of an operating system (OS), an application program module, and other program modules and may be physically stored in various types of well-known storage units.

Middleware of a database (DB) or servers that perform payment processing may be connected to the learner-customized learning service server 300. A description thereof is omitted.

The learner-customized learning service server 300 may download a question to the learner terminal 100, calculate a correct answer rate from a question solving process uploaded by the learner terminal 100, adjust a difficulty level of a next question or a next test according to a correct answer rate of a learner, and provide the adjusted difficulty level to the learner terminal 100. The learner-customized learning service server 300 may average the preset number of correct answer rates, adjust a difficulty level of a next question or a next test, and provide the adjusted difficulty level to the learner terminal 100.

The learner-customized learning service server 300 may selectively download a question and a question solving time limit to the learner terminal 100. The learner terminal 100 may upload a result regarding whether an answer to the question, a solving process of the question, a solving time of the question, and/or a time limit are kept to the learner-customized learning service server 300. The learner-customized learning service server 300 may check a question solving time and question solving processing accuracy based on uploaded contents, calculate a correct answer rate, and calculate accuracy of a learner according to the question solving time, the question solving processing accuracy, and the correct answer rate. The learner-customized learning service server 300 may adjust a difficulty level of a next question or a next test according to such a correct answer rate and provide the adjusted difficulty level to the learner terminal 100. If the correct answer rate of the learner is higher than a reference rate, the learner-customized learning service server 300 may upgrade a difficulty level of a next question or a next test. If the correct answer rate of the learner is lower than the reference rate, the learner-customized learning service server 300 may lower the difficulty level of the next question or the next test.

The learner-customized learning service server 300 may analyze a question solving time, question solving process correctness, a correct answer, and/or accuracy as learning evaluation contents and download the learning evaluation contents to the manager terminal 200 according to a request of the manager terminal 200.

The learner-customized learning service server 300 may download the question solving time, the question processing accuracy, and/or the correct answer except the accuracy to the learner terminal 100 according to a request of the learner terminal 100.

FIG. 2 is a schematic block diagram illustrating a learner terminal 100 that executes a learner-customized learning service application, according to an embodiment of the present invention.

Referring to FIG. 2, the learner terminal 100 includes a controller 110, a display unit 120, a user interface (UI) unit 130, a transceiver 140, and a storage unit 150.

The controller 110 controls an overall operation of the learner terminal 100 and, if a learner-customized learning service application is executed, transmits authentication information to the learner-customized learning service server 300.

If certification is permitted by the learner-customized learning service server 300, the controller 110 also receives and displays a question for a learner. The controller 110 may selectively receive and display a solving time limit of the corresponding question from the learner-customized learning service server 300.

The controller 110 also transmits a question solving process written by the learner to the learner-customized learning service server 300 in real time. In this case, with regard to an objective question, the controller 110 transmits a question solving process written by a learner and an answer selected by the learner to the learner-customized learning service server 300 in real time. The controller 110 may selectively transmit a solving time of the corresponding question to the learner-customized learning service server 300.

The display unit 120 displays a screen on which a learner-customized learning service application is executed. The display unit 120 may display a question in real time and display a question solving result. The display unit 120 may selectively display a solving time limit and a solving process of a corresponding question, and/or a time taken by the solving process. The display unit 120 may include at least one of a liquid crystal display (LCD), an organic light-emitting diode (OLED), an electrophoretic display (EPD), a flexible display, and a 3-dimensional (3D) display. Two or more display units 12 may be included according to a structure of the learner terminal 100.

The UI unit 130 provides an interface for controlling an operation of the learner terminal 100 to a user. In particular, the UI unit 130 receives a control signal of a learner for selectively recording an answer to a question and a solving process of the question by using a learner-customized learning service application and transmits the control signal to the controller 110.

The transceiver 140 transmits and receives data, in particular, transmits and receives data related to a learner-customized learning service application to and from the learner-customized learning service server 300.

The storage unit 150 stores a learning management application, a downloaded question, and a selected answer. The storage unit 150 may also store a question solving time limit, a question solving process of a learner, a question solving time, and an answer. The storage unit 150 may include at least one type of storage medium of a flash memory type, a hard disk type, a multimedia card micro type, a card type memory (for example, a secure digital (SD) or XD memory, or the like), a random access memory (RAM), and a read only memory (ROM).

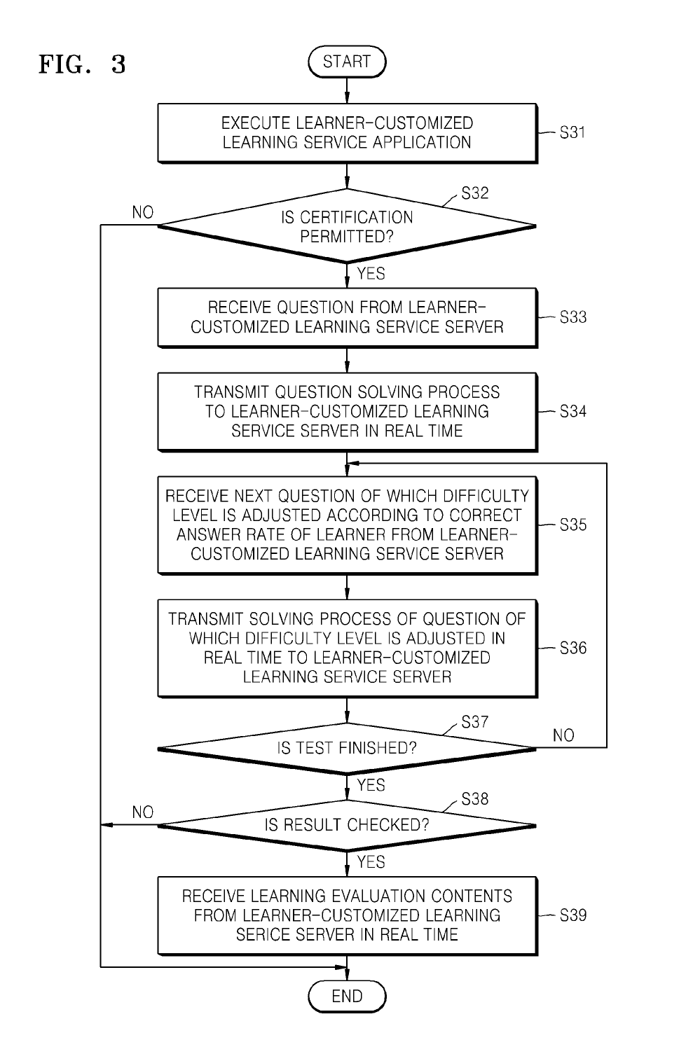

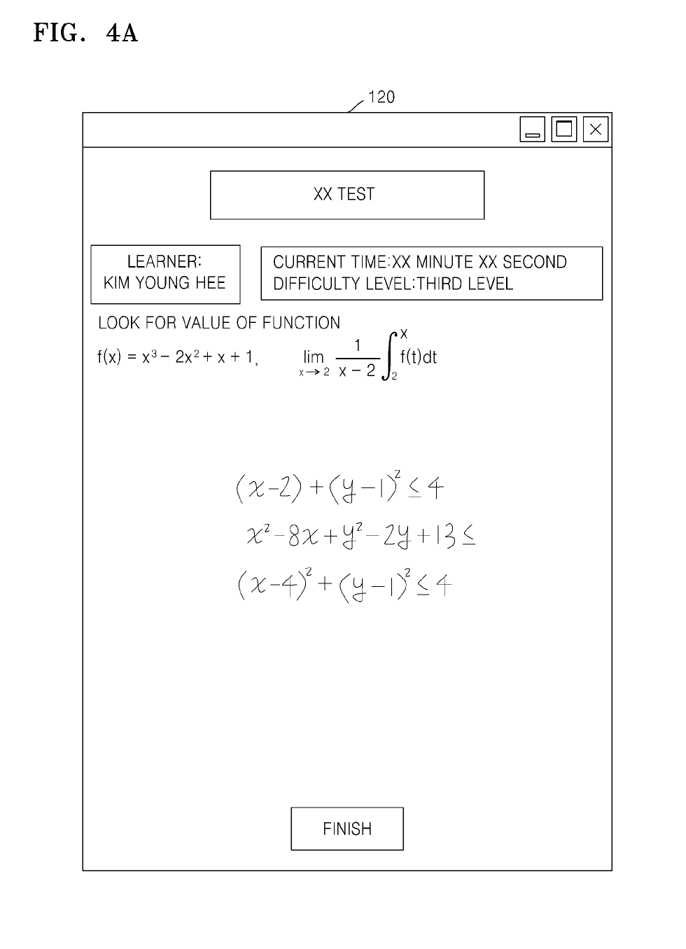

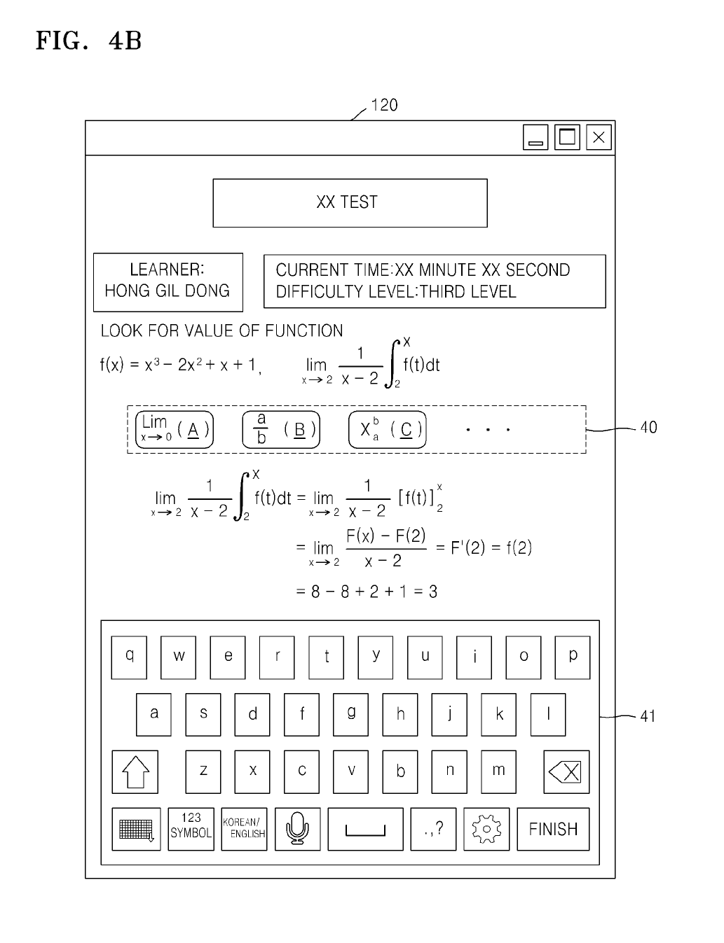

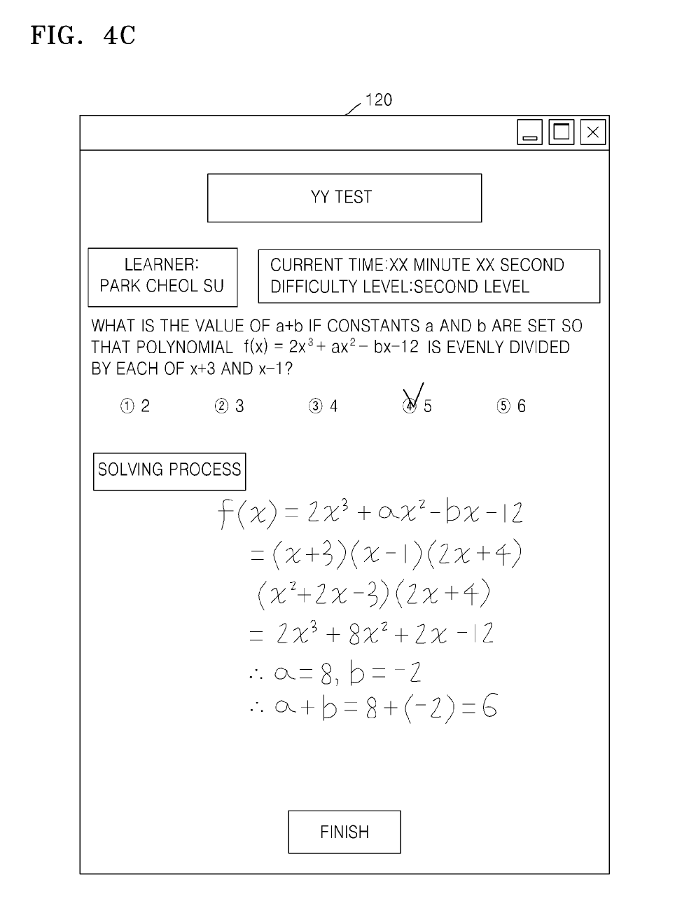

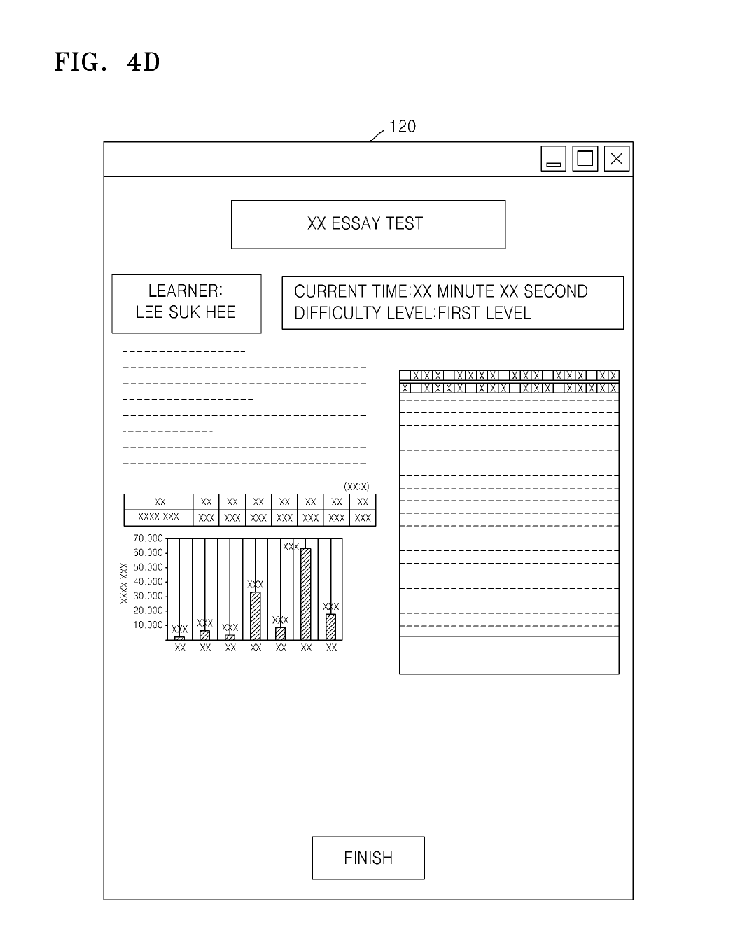

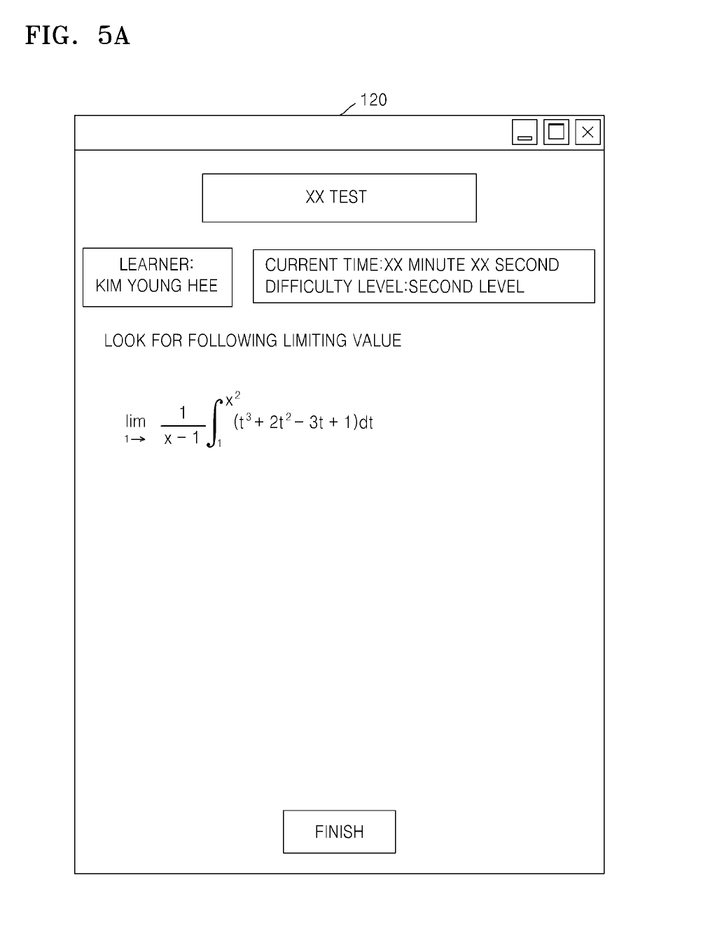

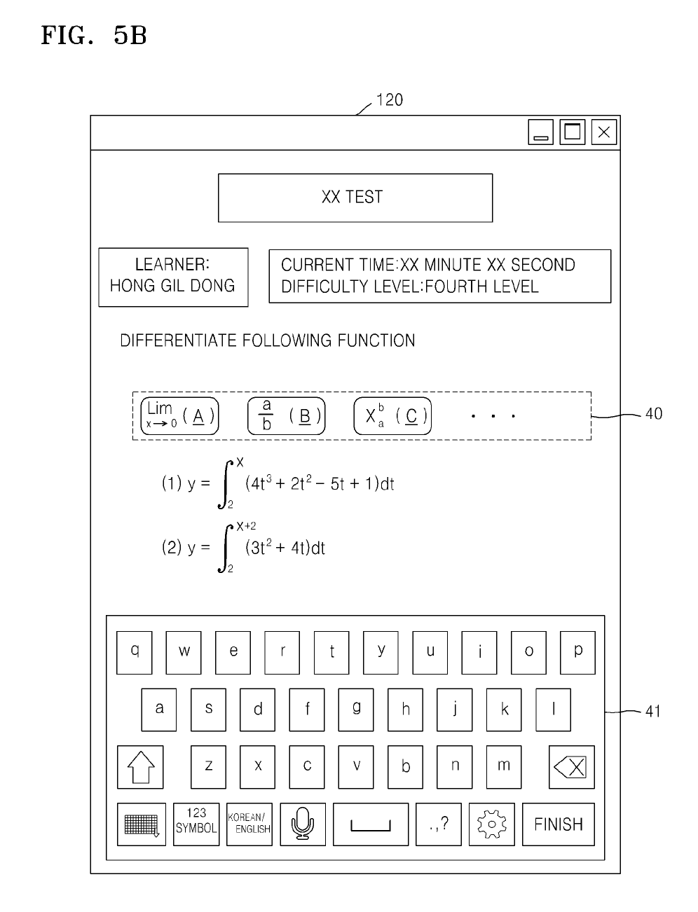

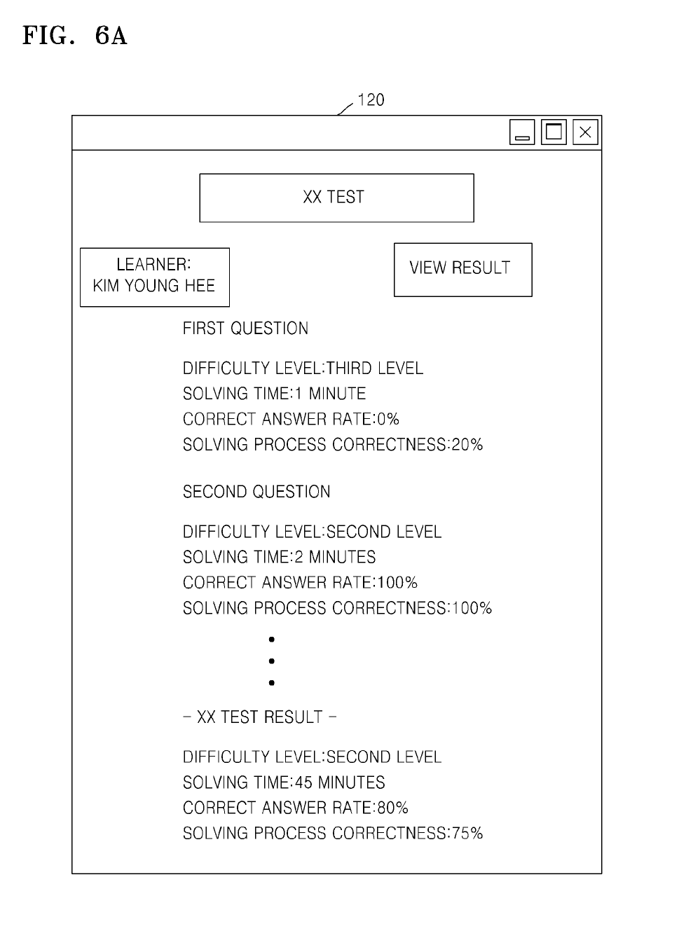

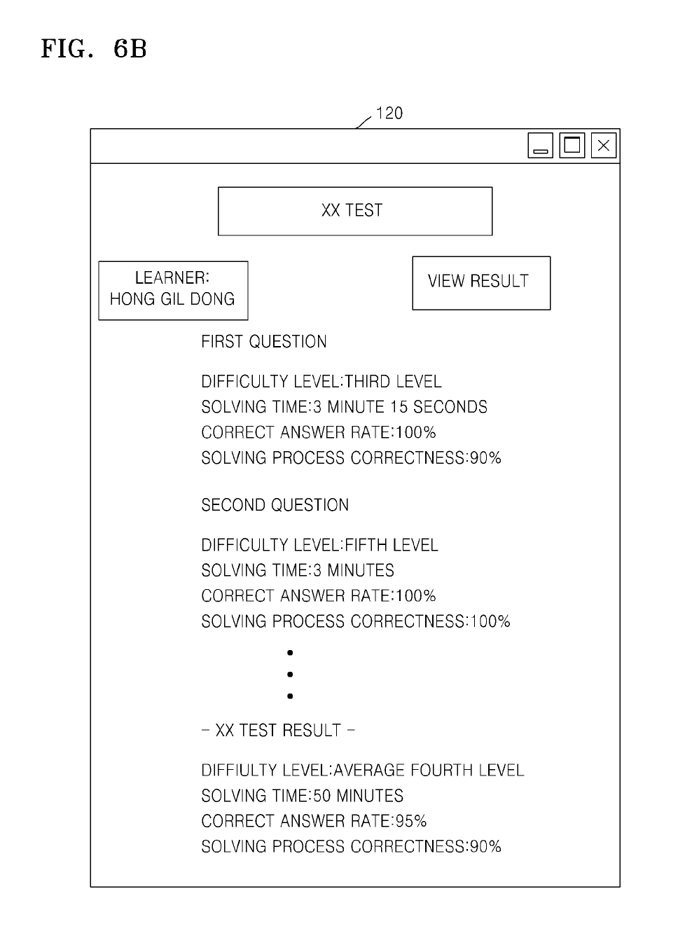

FIG. 3 is a flowchart illustrating a process of transmitting a question solving time and a question solving process through a learner-customized learning service application and checking a transmission result on a learner terminal, according to an embodiment of the present invention. FIGS. 4A through 4D are views illustrating a screen that displays a question solving process on a learner terminal, according to an embodiment of the present invention. FIGS. 5A and 5B are views illustrating a screen for adjusting a difficulty level on a learner terminal, according to an embodiment of the present invention. FIGS. 6A and 6B are views illustrating a screen for checking a question solving result on a learner terminal, according to an embodiment of the present invention.

Referring to FIGS. 3 through 6B, in operation S31, a learner-customized learning service application is executed. In operation S32, the controller 110 receives an ID and a password, which are registered when joining the system, from a learner, and requests certification from the learner-customized learning service server 300 by using the received ID and password. If a learner does not pre-join the system, the controller 110 asks the learner to perform a joining process.

If the certification is permitted by the learner-customized learning service server 300, the controller 110 displays a question, which is transmitted from the learner-customized learning service server 300 and is to be solved by the learner, and a selectively transmitted time limit on the display unit 120 as shown in FIGS. 4A through 4D in operation S33.

In operation S34, the controller 110 transmits a question solving process written by the learner to the learner-customized learning service server 300. The controller 110 may selectively transmit a question solving time to the learner-customized learning service server 300.

FIG. 4A illustrates a process of solving a subjective question having a difficulty level 3 provided to learner “Kim, Young-hee”. As shown in FIG. 4A, a question solving process is written on the learner terminal 100 by using an input unit such as an electronic pen (not shown). If the question solving process is completely written, “finish button” is clicked, and the controller 110 transmits the question solving process written by the learner to the learner-customized learning service server 300. The controller 110 may selectively transmit a question solving time to the learner-customized learning service sever 300.

FIG. 4B illustrates a process of solving a subjective question having a difficulty level 3 provided to learner “Hong, Gil-dong”. Referring to FIG. 4B, a mathematical equation 40 to be used for solving a question and a keyboard 41 are displayed on the display unit 120. Also, a question solving process is written by using the mathematical equation 40 and the keyboard 41. If the question solving process is completely written, “finish button” is clicked, and the controller 110 transmits the question solving process written by the learner to the learner-customized learning service server 300. The controller 110 may selectively transmit a question solving time to the learner-customized learning service server 300.

FIG. 4C illustrates a solving process of an objective question provided to learner “Park, Cheol-su” and a selected answer to the objective question. As shown in FIG. 4C, a question solving process is written by using an input unit such an electronic pen (not shown) or a keyboard, and an answer is selected on the learner terminal 100. If the question solving process and the answer are completely selected, a “finish button” is clicked, and the controller 110 transmits the question solving process written by the learner to the learner-customized learning service server 300. The controller 110 may also selectively transmit a question solving time to the learner-customized learning service server 300.

FIG. 4D illustrates an opinion of learner “Lee, Suk-hee” about an essay question provided to the learner. As shown in FIG. 4D, the opinion of the learner is written on the learner terminal 100 by using an input unit such as an electronic pen (not shown) or a keyboard. If the answer is completely written, the “finish button” is clicked, and the controller 110 transmits the question solving process written by the learner to the learner-customized learning service server 300. The controller 110 may also selectively transmit a question solving time to the learner-customized learning service server 300.

In operation S35, the controller 110 displays on the display unit 120 as shown in FIGS. 5A and 5B a next question of which difficulty level is adjusted according to a correct answer rate of the learner and which is received from the learner-customized learning service server 300. The controller 110 may also selectively display a question solving time limit received from the learner-customized learning service server 300 on the display unit 120.

In operation S36, the controller 110 transmits the question solving process recorded by the learner to the learner-customized learning service server 300. The controller 110 may also selectively transmit the question solving time to the learner-customized learning service server 300.

FIG. 5A illustrates a next question of which difficulty level is adjusted and which is provided to learner “Kim, Young-hee”, i.e., a subjective question of which difficulty level is lowered to a second level. Referring to FIG. 5A, the learner “Kim, Young-hee” may recognize that a previous level question is wrong with reference to a difficulty level of a current question. As shown in FIG. 5A, a question solving process is written on the learner terminal 100 by using an input unit such as an electronic pen (not shown). If the question solving process is completely written, the “finish button” is clicked, and the controller 110 transmits the question solving process written by the learner to the learner-customize learning service server 300. The controller 110 may also selectively transmit a question solving time to the learner-customized learning service server 300.

FIG. 5B illustrates a next question of which difficulty level is adjusted and which is provided to learner “Hong, Gil-dong”, i.e., a subjective problem of which difficulty level is upgraded to a fourth level. Referring to FIG. 5B, the learner “Hong, Gil-dong may recognize that a previous level question is correct with reference to a difficulty level of a current question. As shown in FIG. 5B, a mathematical equation 40 and a keyboard 41 to be used for solving a question are displayed together on the display unit 120. Therefore, if a question solving process is completely written by using the mathematical equation 40 and the keyboard 41, the “finish button” is clicked, and the controller 110 transmits the question solving process written by the learner to the learner-customized learning service server 300. The controller 110 may also selectively transmit a question solving time to the learner-customized learning service server 300.

The controller 110 determines whether a test is finished, and if the test is not finished, the controller 110 goes to operation S35 to continuously receive a question of which difficulty level is adjusted and transmits the question solving process to the learner-customized learning service server 300 in operation s37.

After the test is finished, the controller 110 receives a request signal for checking a question solving result from the learner in operation S38. In operation S39, the controller 110 accesses the learner-customized learning service server 300 to download the question solving result and displays the question solving result on the display unit 39.

FIG. 6A illustrates a question solving result that is downloaded from the learner-customized learning service server 300 according to a request of learner “Kim, Young-hee”. Referring to FIG. 6A, difficulty levels, solving times, correct answer rates, and solving process correctness of all questions, including a difficulty level, a solving time, a correct answer rate, and solving process correctness of each question written by the learner “Kim, Young-hee”, are shown.

FIG. 6B illustrates a question solving result that is downloaded from the learner-customized learning servicer server 300 according to a request of learner “Hong, Gil-dong”. Referring to FIG. 6B, difficulty levels, solving times, correct answer rates, and solving process correctness, including a difficulty level, a solving time, a correct answer, and solving process correctness of each question, are shown.

Besides these, although not shown in the drawings, difficulty levels, solving times, correct answer rates, and solving process correctness of the learners “Park, Cheol-su” and “Lee, Suk-hee” shown in FIGS. 4C and 4D may be shown.

A question solving result is displayed in a text form in FIGS. 6A and 6B. However, a question solving time, a correct answer rate, and a solving process of a learner may be displayed in a figure form or a graphic form.

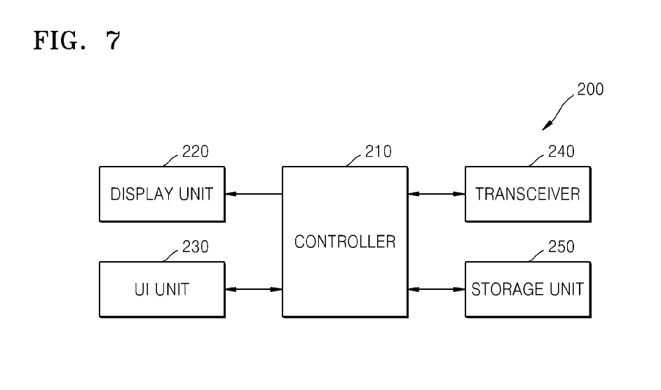

FIG. 7 is a schematic block diagram illustrating a structure of a manager terminal 200 that executes a learner-customized learning service application, according to an embodiment of the present invention.

Referring to FIG. 7, the manager terminal 200 includes a controller 210, a display unit 220, a UI unit 230, a transceiver 240, and a storage unit 250.

The controller 210 controls an overall operation of the manager terminal 200, and if a learner-customized learning service application is executed, transmits certification information to the learner-customized learning service server 300.

If certification is permitted by the learner-customized learning service server 300, the controller 210 receives and displays a learning evaluation content of each learner or learning evaluation contents of all learners to be used by a manager. The controller 210 may receive and display a previous level question of a learner, a next level question, or a difficulty level adjustment menu for adjusting a difficulty level of a next test according to a correct answer rate of a previous test. The controller 210 may receive and display a difficulty level adjustment menu to adjust a difficulty level of a next question or a next test based on the preset number of learning evaluations received from the learner-customized learning service server 300. A difficulty level adjustment is originally performed by the learner-customized learning service server 300, but may be also set by the manager terminal 200 according to a request of the manager.

The display unit 220 displays a screen on which a learner-customized learning service application is executed. The display unit 220 may display a question solving time, a question solving process, question solving process correctness, a correct answer rate, and/or accuracy in real time. The display unit 220 may also display a menu for adjusting a difficulty level and display arbitrary difficulty level setting. The display unit 220 may include at least one of an LCD, an OLED, an EPD, a flexible display, and a 3D display. Two or more display units 220 may be included according to a realization form of the manager terminal 200.

The UI unit 230 provides an interface with a user to control an operation of the manager terminal 200. In particular, the UI unit 230 receives a control signal of the manager for searching for a learning evaluation content by using a learner-customized learning service application and transmits the control signal to the controller 210. The UI unit 230 may also receive a difficulty level set by the manger by using a difficulty level adjustment menu and transmits the difficulty level to the controller 210.

The transceiver 240 transmits and receives data, in particular, transmits and receives data related to a learner-customized learning service application to and from the learner-customized learning service server 300. In particular, the transceiver 240 may transmit and receive the difficulty level set by the manager to and from the learner-customized learning service server 300.

The storage unit 250 stores a learning management application and downloaded learning evaluation contents of a learner, i.e., a question solving time, a question solving process, question solving process correctness, a correct answer rate, and accuracy of the learner. The storage unit 250 may store a difficulty level set by the manager. The storage unit 250 may include at least one type of storage medium such as a flash memory type, a hard disk type, a multimedia card micro type, a card type memory (for example, an SD or XD memory or the like), an RAM, and an ROM.

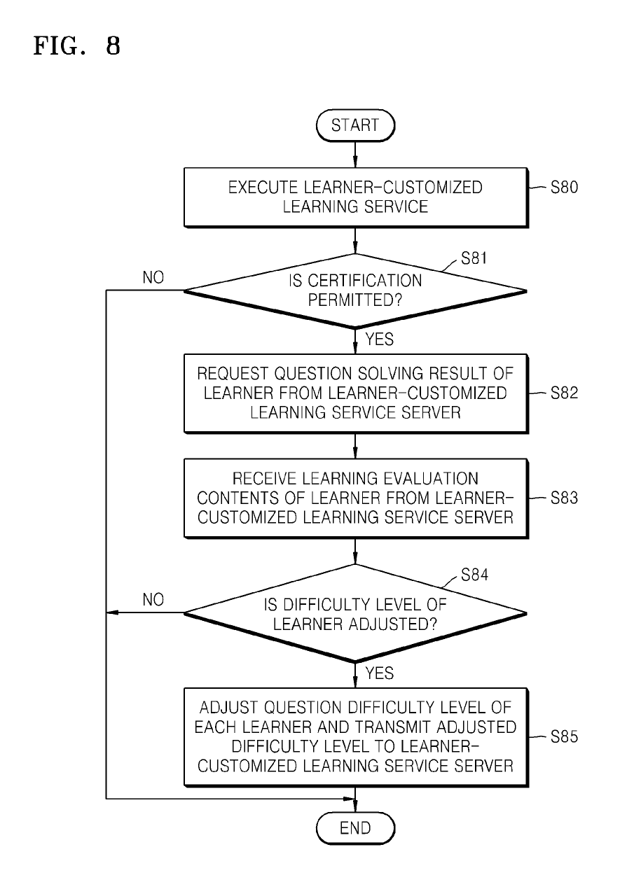

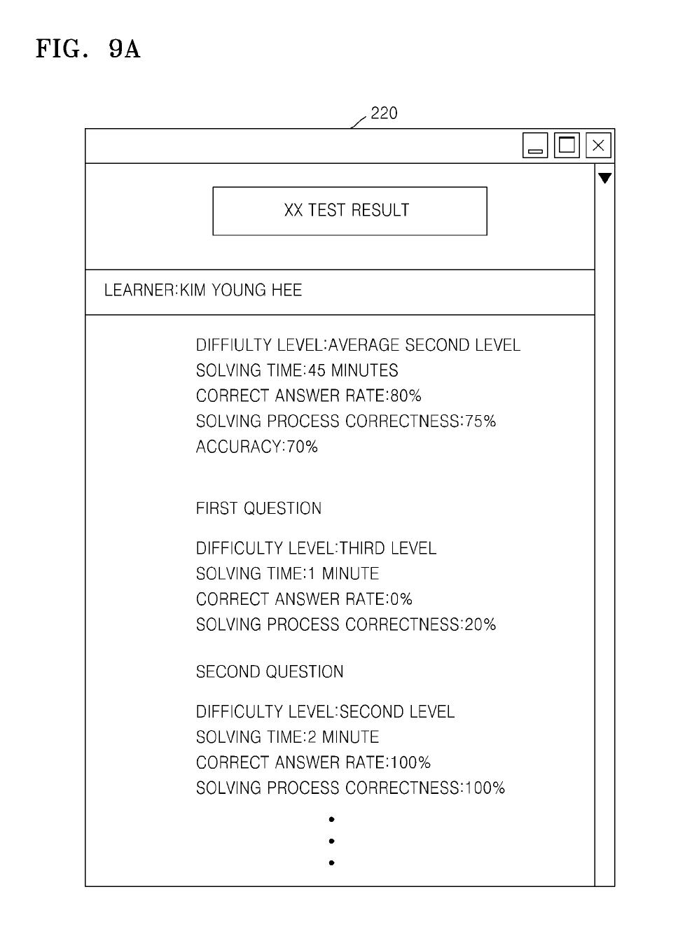

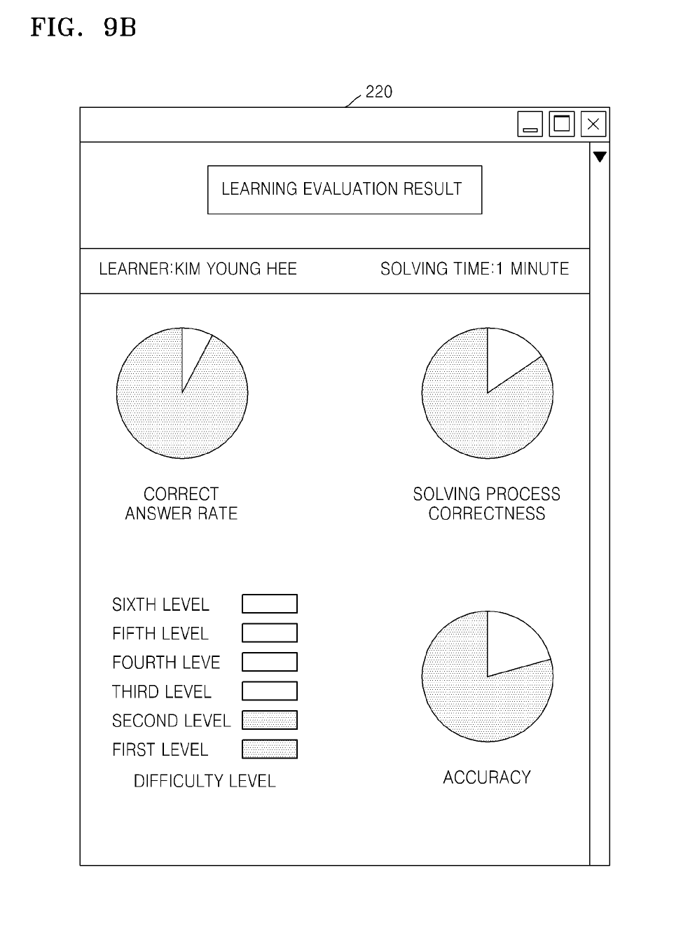

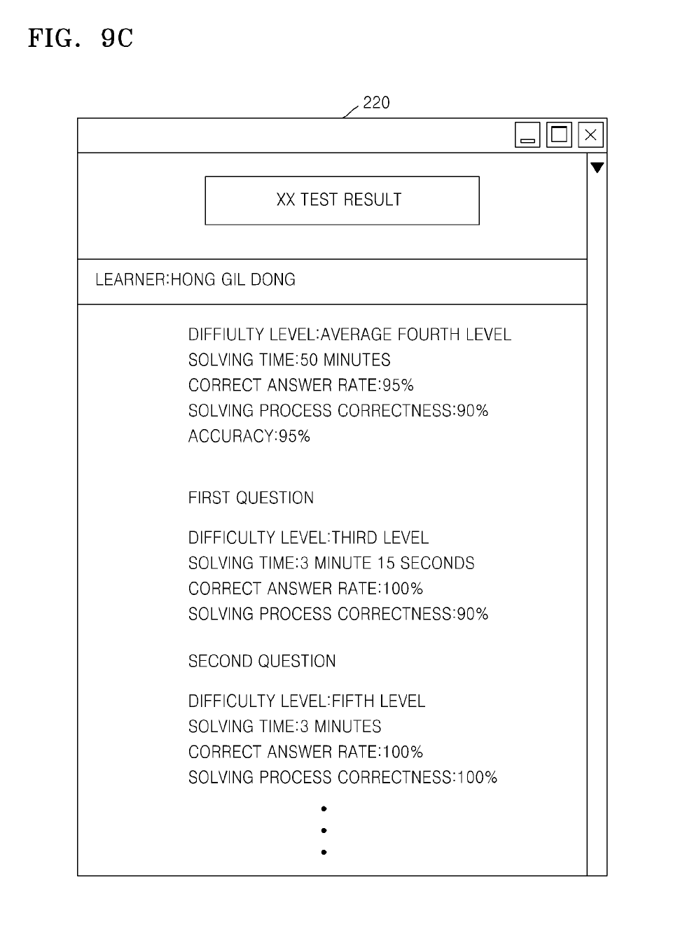

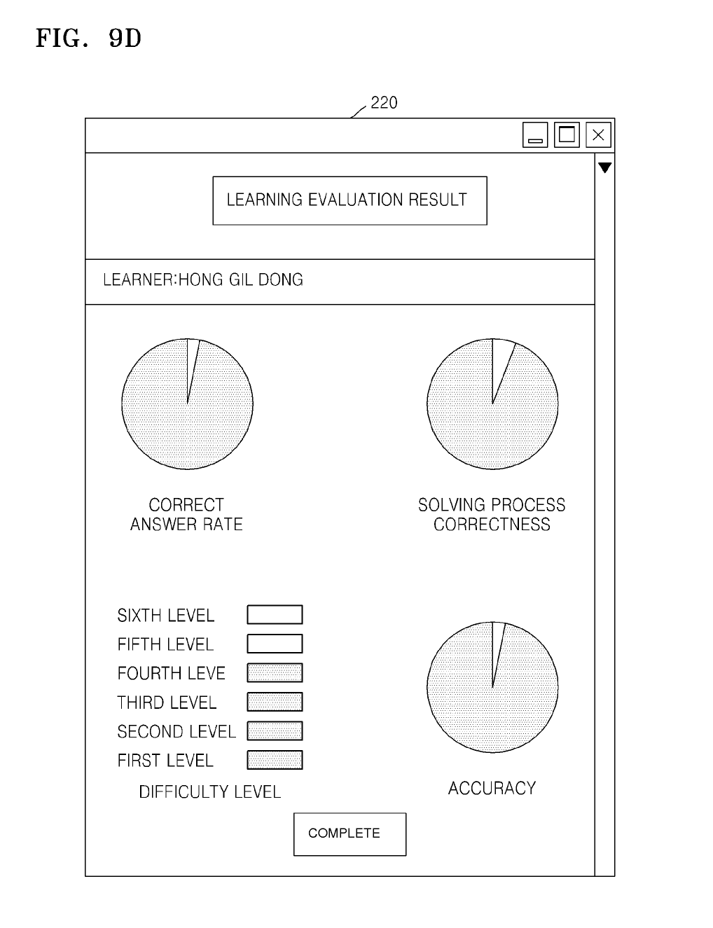

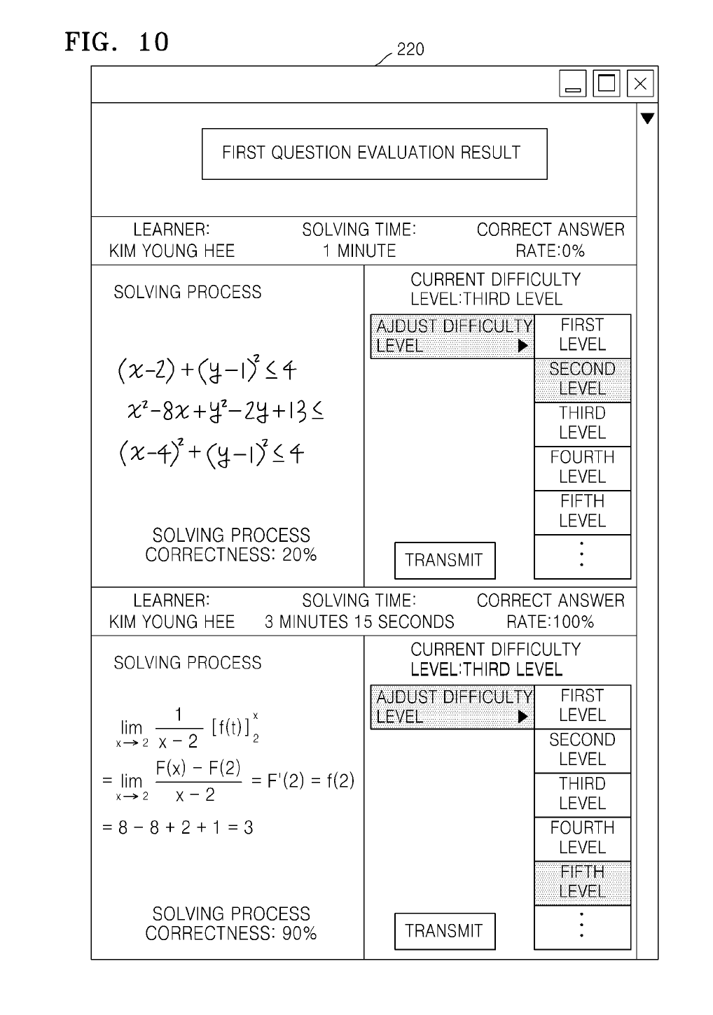

FIG. 8 is a flowchart illustrating a process of checking a question solving result of a learner through a learner-customized learning service application on a manager terminal, according to an embodiment of the present invention. FIGS. 9A through 9D are views illustrating a screen for checking a question solving result of a learner on a manager terminal, according to an embodiment of the present invention. FIG. 10 is a view illustrating a screen for adjusting a difficulty level of a question for a learner on a manager terminal, according to an embodiment of the present invention.

Referring to FIGS. 8 through 10, in operation S80, the controller 210 executes a learner-customized learning service application. In operation S810, the controller 210 receives from a manager an ID and a password registered when joining the system and requests certification from the learner-customized learning service server 300 by using the received ID and password. If the manager does not pre-join the system, the controller 210 first performs a joining process.

If certification is permitted by the learner-customized learning service server 300 in operation S81, the controller 210 requests a question solving result of a learner from the learner-customized learning service server 300 in operation S82. In operation S83, the learner-customized learning service server 300 displays the question solving result of the learner on the display unit 220 as shown in FIGS. 9A and 9B.

FIG. 9A illustrates a question solving result of learner “Kim, Young hee” that is displayed in a text form. Referring to FIG. 9A, difficulty levels, solving times, correct answers, solving process correctness, and accuracy of all questions, including a difficulty level, a solving time, a correct answer, solving process correctness, and accuracy of each question of the learner “Kim, Young-hee”, are displayed. FIG. 9B illustrates a question solving result of learner “Kim, Young-hee” that is displayed in a graphic form. Referring to FIG. 9B, solving process correctness, a correct answer, and accuracy are displayed in graphic forms along with a question solving time of the learner “Kim, Young-hee”.

FIG. 9C illustrates a question solving result of learner “Hong, Gil-dong” that is displayed in a text form. Referring to FIG. 9C, difficulty levels, solving times, correct answers, solving process correctness, and accuracy of all questions, including a difficulty level, a solving time, a correct answer, solving process correctness, and accuracy of each question of the learner “Hong, Gil-dong”, are displayed. FIG. 9D illustrates a question solving result of learner “Hong, Gil-dong” that is displayed in a graphic form. Referring to FIG. 9D, solving process correctness, a correct answer, and accuracy are displayed in graphic forms along with a question solving time of the learner “Hong, Gil-dong”.

Although not shown in the drawings, difficulty levels, solving times, correct answers, solving process correctness, and accuracy of questions for the learner “Park, Cheol-su” and “Lee, Suk-hee” may be displayed in text forms and/or graphic forms.

The solving process correctness may be automatically calculated by a program stored in the learner-customized learning service server 300, but the present invention is not limited thereto. The manager may selectively check a question solving process of a learner and then input an evaluation result of solving process correctness.

In operation S84, the controller 210 receives a question difficulty level request signal of the learner from the manager. In operation S85, the controller 210 receives a question difficulty level adjustment signal of each learner and transmit the question difficulty level adjustment signal to the learner-customized learning service server 300.

FIG. 10 illustrates a difficulty level that is adjusted in the manager terminal 200 according to a question solving result having a third level that is equally provided to learners “Kim, Young-hee” and “Hong, Gil-dong” as shown in FIGS. 4A and 4B. As to the learner “Kim, Young-hee”, a correct answer rate is lower than a reference rate according to a question solving result, and thus, a difficulty level is lowered to a second level. Also, a difficulty level adjustment signal is transmitted to the learner-customized learning service server 300, and thus, the learner-customized learning service server 300 provides the learner terminal 100 with a next level question of which difficulty level is lowered to a second level as shown in FIG. 5A. Regarding the learner “Hong, Gil-dong”, if a correct answer rate is higher than a reference rate according to a question solving result, a difficult level is upgraded to a fourth level. Also, a difficulty level adjustment signal is transmitted to the learner-customized learning service server 300, and thus, the learner-customized learning service sever 300 provide the learner terminal 100 with a next level question of which difficulty level is adjusted to a fourth level as shown in FIG. 5B.

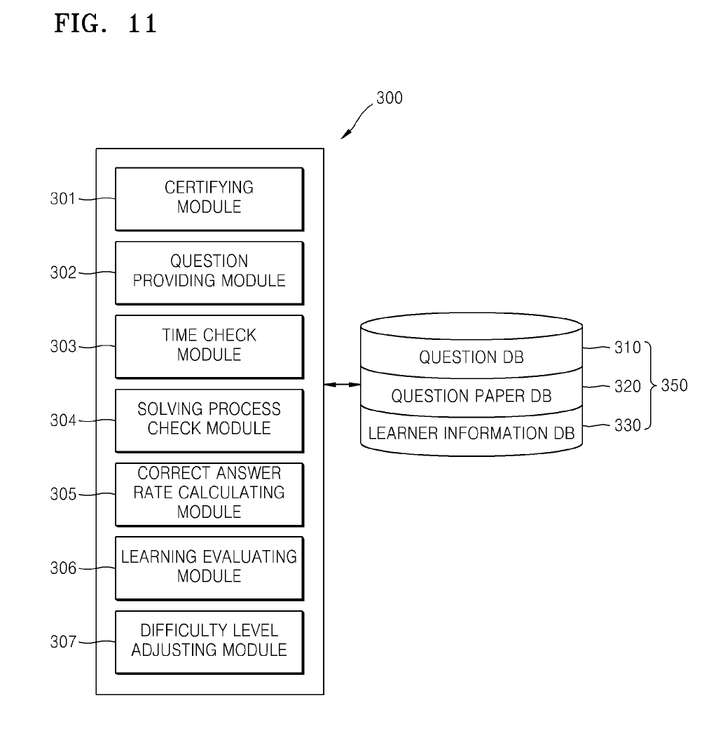

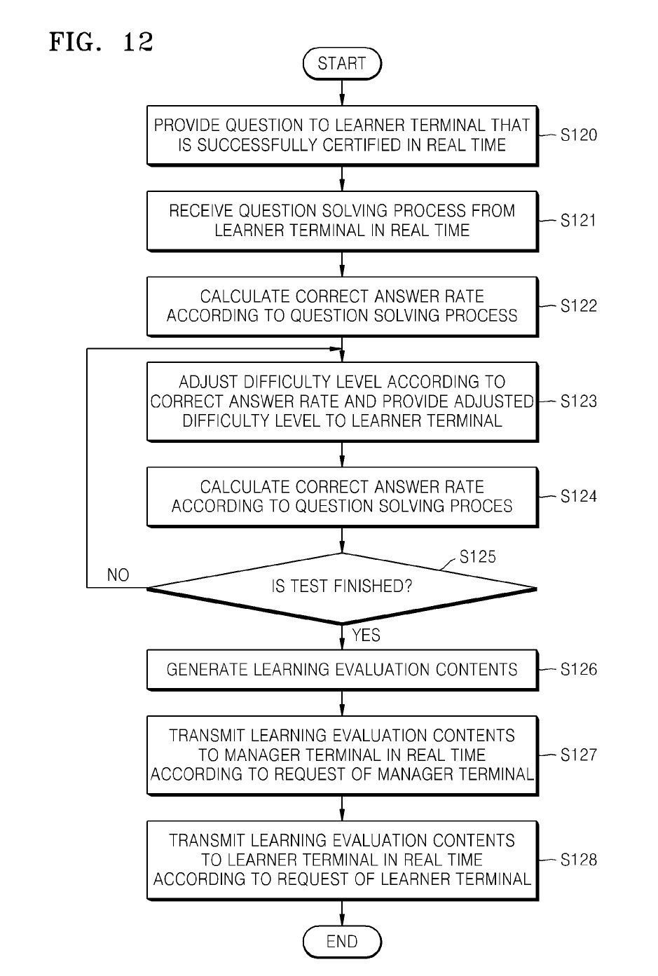

FIG. 11 is a schematic block diagram illustrating a structure of a server 300 for providing a learner-customized learning service, according to an embodiment of the present invention.

Referring to FIG. 11, the server 300 includes a certifying module 301, a question providing module 302, a time check module 303, a solving process check module 304, a correct answer rate calculating module 305, a learning evaluating module 306, a difficulty level adjusting module 307, and a DB 350 including a question DB 310, a learner information DB 320, and a manager information DB 330.

The certifying module 301 certifies a learner and a manger in real time based on information stored in the learner information DB 320 and the manager information DB 330.

The question providing module 302 selectively provides the learner terminal 100 with a question stored in the question DB 310 and a solving time limit of the question in real time. Although not shown in the question DB 310, a question and a solving time limit of the question may be periodically received from a question setting terminal (not shown) and stored. The question DB 310 also stores information related to an answer to the question. The question providing module 302 may provide the manager terminal 200 with the question and the solving limit time of the question stored in the question DB 310.

The time check module 303 checks a question solving time transmitted from the learner terminal 100 in real time. The time check module 303 may be connected to the correct answer rate calculating module 305 to process an answer of a learner who exceeds a time limit as a wrong answer.

Alternatively, the correct answer rate calculating module 305 may calculate a time-based correct answer rate based on a time limit exceeding rate checked by the time check module 303. For example, if a time limit exceeds a first range time (for example, 10 seconds) according to a time check result of the time check module 303, the correct answer rate calculating module 305 may lower a correct answer rate by 5%. If the time limit exceeds a second range time (for example, 30 seconds) according to the time check result of the time check module 303, the correct answer rate calculating module 305 may lower the correct answer rate by 10%. The time-based correct answer rate is provided as a rate exceeding the time limit as described to lower a correct answer rate rather than to process an answer of a learner who solves a question in excess of the time limit as a wrong answer, thereby increasing the efficiency of learning improvement. In this case, a time limit exceeding rate and a lowering range of a correct answer rate may be flexibly adjusted, for example, may be adjusted by a manager.

The solving process check module 304 checks a question solving process transmitted from the learner terminal 100 in real time. The solving process check module 304 may compare the question solving process transmitted from the learner terminal 100 with an answer keyword stored in the question DB 310 and calculate solving process correctness according to the numbers of question solving processes and answer keywords that match with each other. For example, if 10 answer keywords of a question exist, and 10 answer keywords of a solving process exist, the solving process correctness is 100%. The solving process correctness is not acquired by the solving process check module 304 but may be calculated by an input of the manager as described above. Alternatively, a portion of the solving process correctness may be checked by the solving process check module 304, and the other portion of the solving process correctness may be checked by an input of the manager.

The solving process check module 304 may be connected to the correct answer rate calculating module 305 to allow the correct answer rate calculating module 305 to perform correct answer processing if the solving process correctness checked by the solving process check module 304 is higher than or equal to a reference rate, for example, higher than or equal to 90%.

Alternatively, the correct answer rate calculating module 305 may calculate a correct answer rate based on the solving process correctness checked by the solving process check module 304. For example, if the correct answer rate is in a first range (for example, between 80% and 89%) according to the solving process correctness check result of the solving process check module 304, the correct answer rate calculating module 305 may lower the correct answer rate by 5%. If the correct answer rate is in a second range (for example, between 70% and 79%) according to the solving process correctness check result of the solving process check module 304, the correct answer rate calculating module 305 may lower the correct answer rate by 10%. A time-based correct answer rate is provided according to a solving process correctness rate to lower a correct answer rate rather than to process an answer of a learner who writes a less correct solving process as a wrong answer, thereby increasing the efficiency of the learning improvement. In this case, a solving process correctness rate and a lowering range of a correct answer rate may be flexibly adjusted, for example, by the manager.

The correct answer rate calculating module 305 may calculate a correct answer rate in real time by using various methods. For example, although a solving process correctness of a question of a learner who exceeds a time limit is higher than or equal to a reference rate, an answer of the learner may be processed as a wrong answer. Alternatively, if a solving process is written within a time limit, and the correctness of the solving process is lower than or equal to a reference rate, the answer of the learner may be processed as a wrong answer. Also, if the correctness of the solving process is higher than or equal to the reference rate written with the time limit, the answer of the learner may be processed as a correct answer. As described above, a time-based correct answer rate and a solving process correctness-based correct answer rate may be summed to calculate a correct answer rate. In this case, the correct answer rate may be expressed as “correct/wrong” or as a percentage but is not limited thereto. The correct answer rate may be expressed by using various methods.

The learning evaluating module 306 analyzes a question solving time, question solving process correctness, and a correct answer, and generates learning evaluation contents including accuracy of the learner according to the analysis result. In this case, a method of calculating accuracy according to an embodiment will now be described. A first weight may be applied to a question solving time, a second weight may be applied to question solving process correctness, and the results may be added in order to calculate accuracy. In this case, the first and second weights may be flexibly adjusted, for example, by the manager. A manager who gives considerably thought to the question solving time may set the first weight to be higher than the second weight. A manager who gives considerable thought to the question solving process may set the second weight to be higher than the first weight.

The learning evaluating module 306 may provide the generated learning evaluation contents to the manager terminal 200 in text forms and/or graphic forms according to a request of the manger terminal 200. The learning evaluating module 306 may provide the learning evaluation contents except accuracy to the learner terminal 100 according to a request of the learner terminal 100.

The difficulty level adjusting module 307 may adjust a difficulty level of a next question or a next test according to the correct answer rate of the learning evaluation contents and provide the adjusted difficulty level to the learner terminal 100. The difficulty level adjusting module 307 may also adjust the difficulty level of the next question or the next test based on the preset number of learning evaluations and provide the adjusted difficulty level to the learner terminal 100. In this case, if a correct answer rate of a learner is higher than a reference rate, the difficulty level adjusting module 307 may upgrade the difficulty level of the next question or the next test. If the correct answer rate of the learner is lower than the reference rate, the difficult level adjusting module 307 may lower the difficulty level of the next question or the next test.

The difficulty level adjusting module 307 may also receive a difficulty level adjusted by the manager terminal 200 from the manager terminal 200, adjust the difficulty level of the next question or the next test according to the received difficulty level, and provide the adjusted difficulty level to the learner level 100.

FIG. 12 is a flowchart illustrating a process of adjusting a difficulty level of each learner according to a correct answer rate through a server for providing a learner-customized learning service and providing the adjusted difficulty level to a manager terminal and a learner terminal, according to an embodiment of the present invention.

Referring to FIG. 12, in operation S120, the learner-customized learning service server 300 provides a question or a question solving time limit to the learner terminal 100 that succeeds in being certified in real time.

In operation S121, the learner-customized learning service server 300 receives a question solving process from the learner terminal 100 in real time. In this case, the learner-customized learning service server 300 may selectively receive a question solving time from the learner terminal 100.

In operation S122, the learner-customized learning service server 300 calculates a correct answer rate based on question solving process correctness that is acquired by comparing the real-time received question solving process with an answer keyword stored in a question DB. The learner-customized learning service server 300 may also calculate the correct answer rate based on question solving process correctness that is acquired by comparing a real-time received question solving time of a learner with a time limit and comparing the real-time received question solving process with the answer keyword stored in the question DB. If the question solving time of the learner exceeds the time limit, the learner-customized learning service server 300 may process an answer of the learner as a wrong answer. The learner-customized learning service server 300 may also calculate a time-based correct answer rate based on a time limit exceeding rate. For example, if the question solving time of the learner exceeds a first range time (for example, 10 seconds) according to a time check result of the time check module 303, the correct answer rate calculating module 305 may lower the correct answer rate by 5%. A time limit exceeding rate and a lowering range of a correct answer rate may be flexibly adjusted, for example, may be adjusted by the manager. Also, the learner-customized learning service server 300 may not provide a question solving time limit. In this case, the learner-customized learning service server 300 may process an answer of a learner as a wrong answer or calculate a time-based correct answer rate according to a preset reference time of question solving and whether a real-time received question solving time of the learner exceeds the reference time. The learner-customized learning service server 300 may also calculate a correct answer rate based on a solving process correctness rate. For example, if the solving process correctness rate is in a first range (for example, between 80% and 90%) according to a solving process correctness check result, the correct answer rate calculating module 305 may lower the correct answer by 5%. Although solving process correctness of a question of a learner who exceeds a time limit is higher than or equal to a reference rate, the learner-customized learning service server 300 may process an answer of the learner as a wrong answer. Alternatively, if a solving process is written within a time limit, and solving process correctness is lower than the reference rate, the learner-customized learning service server 300 may process the answer of the learner as the wrong answer. Also, if the solving process correctness is higher than or equal to the reference rate, the learner-customized learning service server 300 may process the answer of the learner as a correct answer. In addition, as described above, a time-based correct answer rate and a solving process correctness-based correct answer rate may be summed to calculate a correct answer rate. The correct answer rate may be expressed as “correct/wrong” or as a percentage. However, the present invention is not limited thereto and the correct answer may be expressed by using various methods.

In operation S123, the learner-customized learning service server 300 adjusts a difficulty level of a next question or a next test according to the correct answer rate of the learner and provides the adjusted difficulty level to the learner terminal 100. If the correct answer rate of the learner is higher than the reference rate, the learner-customized learning service server 300 may upgrade the difficulty level of the next question or the next test. If the correct answer rate is lower than the reference rate, the learner-customized learning service server 300 may lower the difficulty level of the next question or the next test. Alternatively, the learner-customized learning service server 300 may receive a difficulty level adjusted by a manager from the manager terminal 200, adjust a difficulty level of a next question or a next test according to the received difficulty level, and provide the adjusted difficulty level to the learner terminal 100.

In operation S124, the learner-customized learning service server 300 calculates a correct answer rate based on question solving process correctness that is acquired by comparing a question solving process of the learner of the question having the adjusted difficulty level with an answer keyword stored in a question DB.

In operation S125, the learner-customized learning service server 300 determines whether a test is finished. If the test is not finished, the learner-customized learning service server 300 moves to operation S123 to adjust the difficulty level, transmits the adjusted difficulty level to the learner terminal 100, receives a question solving process from the learner terminal 100 in real time, and calculates a correct answer rate.

If the test is finished, the learner-customized learning service server 300 analyzes the question solving time, the question solving process correctness, and the correct answer rate, and generates learning evaluation contents including accuracy of the learner according to the analysis result. A method of calculating the or accuracy will now be described. A first weight may be applied to the question solving time and a second weight may be applied to the question solving process correctness to add them in order to calculate the or accuracy. The first and second weights may be flexibly adjusted.

In operation S127, the learner-customized learning service server 300 transmits learning evaluation contents in text forms and/or graphic forms in real time to the manager terminal 200 according to a request of the manager terminal 200 that is successfully certified.

In operation S128, the learner-customized learning service server 300 transmits learning evaluation contents except or accuracy in text forms and/or graphic forms to the learner terminal 100 in real time according to a request of the learner terminal 100.

As described above, according to the one or more of the above embodiments of the present invention, a correct answer rate may be checked based on a real-time solving process and/or a solving time of a question addressed to a learner by using a fixed terminal such as a personal computer or a portable terminal such as a smartphone. A difficulty level may be adjusted and provided according to the correct answer rate to accurately analyze a learning type of each learner in order to improved learning.

Also, a learning process appropriate for a level of each learner may be provided to induce step-by-step and self-directed learning.

A correct answer rate may be checked based on a real-time solving process and/or solving time of a question addressed to a learner by using a fixed terminal such as a personal computer or a portable terminal such as a smartphone in order to induce accurate learning of a learner.

A real-time solving process and/or solving time of a question addressed to a learner may be checked regardless of time and place by using a terminal such as a fixed terminal such a personal computer or a portable terminal such as a smartphone.

The learner may check a correct answer rate of a question solved by the learner in real time to improve learning efficiency.

The present invention may also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A method of providing a learner-customized learning service through a server, the method comprising:
providing a question to a learner terminal;
receiving a solving process of the question from the learner terminal in real time;
calculating a solving process correctness and a correct answer rate of the question received from the learner terminal in real time; and
adjusting a difficulty level of the question provided to the learner terminal according to the correct answer rate.

2. The method of claim 1, further comprising:
providing learning evaluation contents in real time according to a request of the learner terminal and/or a manager terminal.

3. The method of claim 2, further comprising:
providing the learning evaluation contents in text forms and/or graphic forms in real time according to a request of the learner terminal.

4. The method of claim 2, further comprising:
adjusting and transmitting the difficulty level of the question provided to the learner terminal according to the learning evaluation contents through the manager terminal.

5. The method of claim 4, further comprising:
if the correct answer rate of the learning evaluation contents of the learner terminal is higher than a reference rate, upgrading and transmitting a difficulty level through the manager terminal, and if the correct answer rate of the learner terminal is lower than the reference rate, lowering and transmitting a difficulty level through the manager terminal.

6. The method of claim 1, wherein the providing of the learning evaluation contents comprises:
comparing the solving process with an answer keyword; and
calculating the solving process correctness according to the numbers of solving processes and the answer keywords that match with each other.

7. The method of claim 7, further comprising:
if the solving process correctness is higher than or equal to the reference rate, processing an answer of the learner as a correct answer.

8. The method of claim 1, wherein the providing of the learning evaluation contents further comprises:
receiving a solving time of the question,
wherein if the solving time of the question exceeds a time limit or a preset reference time provided to the learner terminal, processing the answer of the learner terminal as a wrong answer.

9. The method of claim 1, wherein the providing of the learning evaluation contents further comprises:
receiving a solving time of the question,
wherein a first weight is applied to the solving time, and a second weight is applied to the solving process correctness to calculate a accuracy

10. The method of claim 1, wherein the providing of the learning evaluation contents comprises:
calculating the correct answer rate according to the solving time and solving process correctness of the question.

11. The method of claim 1, wherein the adjusting of the difficulty level comprises:
determining the difficulty level of the learner terminal based on the preset number of learning evaluations.

12. The method of claim 1, wherein the adjusting of the difficulty level comprises:
adjusting a difficulty level of each question of the learner terminal and providing the adjusted difficulty level to the learner terminal.

13. The method of claim 12, further comprising:
if a correct answer of each question of the learner terminal is higher than a reference rate, upgrading and transmitting a difficulty level of a next question, and if the correct answer of each question of the learner terminal is lower than the reference rate, lowering and transmitting the difficulty level of the next question.

14. The method of claim 1, wherein the adjusting of the difficulty level comprises:
adjusting a difficulty level of each test of the learner terminal and providing the adjusted difficulty level to the learner terminal.

15. The method of claim 14, further comprising:
if a correct answer rate of each test of the learner terminal is higher than a reference rate, upgrading and transmitting a difficulty level of a next test, and if the correct answer rate of each test of the learner terminal is lower than the reference rate, lowering and transmitting the difficulty level of the next test.

16. A server for providing a learner-customized learning service, the server comprising:
a question providing module which provides a question to a learner terminal;
a solving process check module which calculates a solving process correctness of the question received from the learner terminal;
a correct answer rate calculating module which calculates a correct answer rate according to the solving process correctness;
a learning evaluating module which generates in real time learning evaluation contents comprising a solving time, the solving process correctness, the correct answer rate, and accuracy of the question according to each learner terminal; and
a difficulty level adjusting module which adjusts a difficulty level of the learner terminal according to the correct answer rate.

17. The server of claim 16, wherein the learning evaluating module provides the learning evaluation contents in real time according to a request of the learner terminal and/or a manager terminal.

18. The server of claim 16, wherein the manager terminal adjusts and transmits a difficulty level of the question of the learner terminal according to the learning evaluation contents.

19. The server of claim 16, wherein the difficulty level adjusting module adjusts a difficulty level of each question of the learner terminal and provides the adjusted difficulty level to the learner terminal.

20. The server of claim 16, wherein the difficulty level adjusting module adjusts a difficulty level of each test of the learner terminal and provides the adjusted difficulty level to the learner terminal.
